(19) United States
(12) Patent Application Publication
(10) Pub. No.: US 2006/0141381 A1
(43) Pub. Date: Jun. 29, 2006

(54) Photosensitive resin composition, and photosensitive element, method for forming resist pattern and printed wiring board using the composition

(75) Inventors: Toshizumi Yoshino, Ibaraki (JP); Kuniaki Satou, Ibaraki (JP); Masayoshi Joumen, Ibaraki (JP); Masayuki Hama, Ibaraki (JP); Keishi Hamada, Ibaraki (JP); Tsutomu Mamiya, Ibaraki (JP); Tooru Katsurahara, Ibaraki (JP); Kenichi Kawaguchi, Ibaraki (JP)

Correspondence Address: GRIFFIN & SZIPL, PC, SUITE PH-1, 2300 NINTH STREET, SOUTH, ARLINGTON, VA, 22204, US

(73) Assignee: Hitachi Chemical Co., Ltd., Shinjuku-ku, Tokyo (JP)

(21) Appl. No.: 10/530,677

(22) PCT Filed: Oct. 8, 2003
(86) PCT No.: PCT/JP03/12910

§ 371 Date: Nov. 10, 2005

(30) Foreign Application Priority Data
Oct. 8, 2002 (JP) 2002-295287

(51) Int. Cl. G03C 1/76

(52) U.S. Cl. 430/270.1

(57) ABSTRACT

A photosensitive resin composition, characterized in comprising: (A) a polymer having a carbon hydrocarbon double bond and carboxyl group, formed by the reaction of an acid anhydride with the reaction product of an epoxy compound having a structure wherein a glycidyloxy group is bonded to a main chain comprising an aromatic ring, an alkylene group and an oxygen atom, with an unsaturated carboxyl compound having a carbon-carbon double bond and a carboxyl group, (B) a photopolymerizable monomer, (C) a radical photopolymerization initiator, and (D) a curing agent having reactivity with the functional groups of the polymer and/or the photopolymerizable monomer. Using this photosensitive resin composition, a solder resist having excellent resolution, adhesion, PCT resistance, electrical corrosion resistance, heat resistance and thermal impact resistance can be formed.

### TECHNICAL FIELD

The present invention relates to a photosensitive resin composition, photosensitive element using same, resist pattern-forming method and printed circuit board.

### BACKGROUND ART

In the prior art, in order to protect the conductor layer surface of a printed circuit board, a solder resist was formed on the surface concerned. In a Ball GridArray (BGA), Pin Grid Array (PGA), Chip Scale Package (CSP), etc., the solder resist, in a soldering process for mounting components on the printed circuit, has the role of preventing solder from adhering to unnecessary parts of the conductor layer and has the additional role of acting as a permanent mask for protecting the conductor layer of the printed circuit after mounting components.

Although a method of, for example, screen-printing a thermosetting resin on the conductor layer of the printed circuit was known as a method of forming such a solder resist, according to this method it was difficult to achieve high resolution of the resist pattern.

Hence, one method of attaining high resolution of the resist pattern was developed an alkali developing resist pattern was formed using a photosensitive resin composition. In this method, a layer of the photosensitive resin composition was formed on the conductor layer of the printed circuit, a predetermined part was cured by irradiating it with an activating light, and the unexposed part was removed with an alkali solution to form high resolution of the resist pattern. The photosensitive resin composition used for this method may for example be the liquefied resist ink composition disclosed in JP-A 61-243869, or the photosensitive thermosetting resin composition disclosed in JP-A 1-141904.

### DISCLOSURE OF THE INVENTION

However, although a high resolution can be attained in the aforesaid method of forming an alkaline developing resist pattern using the photosensitive resin composition of the prior art, the photosensitive resin composition layer, which was the solder resist, had poor adhesion to the printed circuit conductor layer, and there was also the problem that the photosensitive resin composition layer peeled away from the printed circuit. Further, when the printed circuit provided with this solder resist was exposed to high temperature and high humidity in a pressure cooker test (PCT) for several hours, the solder resist occasionally swelled up and the electrical properties of the solder resist declined. Thus, this printed circuit had inadequate PCT resistance and electrical corrosion resistance.

In recent years, many mounting components are being mounted not by intercalation mounting but by surface mounting using solder. In surface mounting, a cream solder is applied to the joining part of the mounting component of the printed circuit beforehand, and a whole printed circuit is heated by infrared radiation, etc., to cause reflow of solder to join the mounting component. In this case, however, when the whole printed circuit was exposed to high temperature and the photosensitive resin composition of the prior art was used as the solder resist for the mounting, there was a tendency for cracks and peeling to occur in this resist due to thermal impacts such as rapid temperature changes. For this reason, the printed circuit provided with the aforesaid solder resist had inadequate heat-resisting properties and thermal impact resistance to perform surface mounting.

It is therefore an object of the present invention, which was conceived in view of these problems, to provide a photosensitive resin composition which can form a solder resist that not only has high resolution, but also has excellent adhesion, PCT resistance, electrical corrosion resistance, heat-resisting properties and thermal impact resistance. It is a further object of the invention to provide a method of forming the resist pattern using this photosensitive resin composition, and a printed circuit.

To achieve the above objects, the invention provides a photosensitive resin composition, comprising
(A) a polymer having a carbon-carbon double bond and a carboxyl group formed by reaction of an acid anhydride with the reaction product of an epoxy compound having a repeating unit expressed by the following general formula (1a) and a repeating unit expressed by (1b), with an unsaturated carboxyl compound having a carbon-carbon double bond and a carboxyl group (hereafter, “Component A”), (B) a photopolymerizable monomer (hereafter, “Component B”), (C) a radical photopolymerization initiator (hereafter, “Component C”), and (D) a curing agent which reacts with carboxyl groups (hereafter, “Component D”):

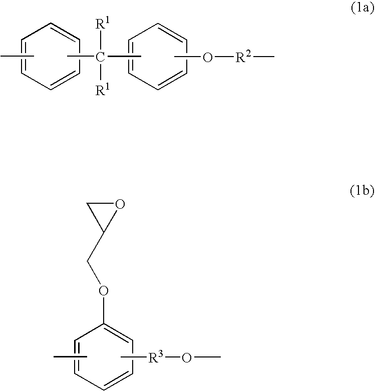

[In the formula, R¹ is a hydrogen atom or a methyl group, and R², R³ are alkylene groups].

In the photosensitive resin composition of the invention, it is thought that Component B and Component D combine with Component A which is a binder polymer by different reaction pathways to form a crosslinked material so that a high resolution resist pattern can be formed. Also, when a cured material is used as the solder resist of a printed circuit, the adhesion of the solder resist to the conductor layer of the printed circuit can be increased, and the peeling of the solder resist can be largely reduced. The PCT resistance, electrical corrosion resistance, heat-resisting property and thermal impact resistance of the solder resist can also be increased.

The aforesaid epoxy compound is preferably the polymer expressed by the following general formula (2): 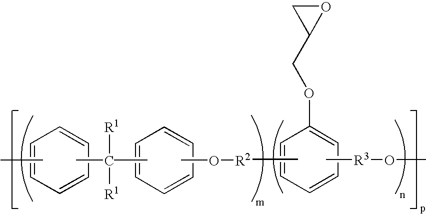
[in the formula, R¹ is a hydrogen atom or a methyl group, R², R³ are alkylene groups, m and n are positive integers such that m+n is 2-50, and p is a positive integer].

If the polymer expressed by the aforesaid general formula (2) is used as the epoxy compound, peeling of the solder resist when the cured material is used as the solder resist is rendered still more difficult.

The unsaturated carboxyl compound is preferably the compound expressed by the following general formula (3), and this compound is more preferably (meth)acrylic acid: 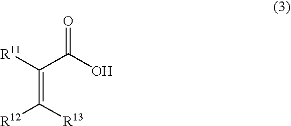
[in the formula, R¹¹ is a hydrogen atom or an alkyl group, R¹², R¹³ are respectively a hydrogen atom, alkyl group, aryl group, styryl group, furfuryl group or cyano group].

A monoester of a dibasic acid having a carbon-carbon double bond (hereafter, “unsaturated dibasic acid monoester”) can also be used as the unsaturated carboxyl compound. This unsaturated dibasic acid monoester is more preferably a monoester obtained by reacting an acid anhydride and a (meth)acrylate compound having a hydroxyl group.

By using the compound expressed by the aforesaid general formula (3) or unsaturated dibasic acid monoester as the unsaturated carboxyl compound, the crosslinking density of the photosensitive resin composition is increased and a tougher cured material can be obtained.

The aforesaid photosensitive resin composition preferably contains an elastomer and/or phenoxy resin.

By containing an elastomer or phenoxy resin in the photosensitive resin composition, adhesion to the conductor layer of the obtained solder resist is further improved.

The aforesaid photosensitive resin composition more preferably contains a block isocyanate. By containing a block isocyanate, a tough cured material of high crosslinking density can be obtained.

In addition to the aforesaid components, a non-elastomer-like polymer of a polymerizable compound having a carbon-carbon double bond can also be contained in the photosensitive resin composition of the invention.

If the photosensitive resin composition contains such a polymer, a cured material of higher strength can be obtained, and adhesion to the circuit-forming substrate is still further improved.

The invention provides a photosensitive element comprising a support, and the photosensitive resin composition layer of the invention formed on the support.

The invention provides a method of forming a resist pattern, comprising the steps of laminating a photosensitive resin composition layer comprising the photosensitive resin composition of the invention to cover a conductor layer on an insulating substrate in a laminated circuit board provided with the insulating substrate and the conductor layer having a circuit pattern formed on the insulating substrate, forming an exposed part by irradiating a predetermined part of this photosensitive resin composition layer with activation light, and removing parts other than this exposed part.

The invention further provides a printed circuit board having an insulating substrate, a conductor layer having a circuit pattern formed on this insulating substrate, and a resist layer formed on the insulating substrate so as to cover the conductor layer, the resist layer being a cured material of the photosensitive resin composition of the invention, and this resist layer having an opening so that at least part of the conductor layer is exposed.

### BRIEF DESCRIPTION OF THE DRAWINGS

FIG. 1 is a schematic cross-sectional view showing one embodiment of a photosensitive element.

FIG. 2 is a schematic cross-sectional view showing one embodiment of a printed circuit.

### BEST MODES FOR CARRYING OUT THE INVENTION

The photosensitive resin composition of the invention contains Components A-D as mentioned above. It may be conjectured that in this photosensitive resin composition, curing (crosslinking) occurs due to exposure to the activation light by the plural routes shown below. It is further conjectured that when curing occurs by such plural routes, the outstanding characteristics mentioned above are obtained. Specifically, since Component A which functions as a binder polymer has a carbon-carbon double bond, when Component B polymerizes, Component

A is also included in the polymerization and a crosslinked structure is formed.

Further, since Component A also has a carboxyl group, by using Component D as a curing agent which has reactivity with the carboxyl group, a crosslinked structure of Component A and Component D is formed. Moreover, when Component D is a curing agent which can react also with functional groups (for example, hydroxyl groups) in Component B, it reacts with Component B which has been polymerized so as to form a crosslinked structure. Component C is a component which generates active species (radicals) by light irradiation, and initiates the polymerization of Component B or Component A.

However, the curing mechanism is not necessarily limited to the above.

(Component A)

Component A is a polymer having a carbon-carbon double bond and a carboxyl group formed by the reaction of the reaction product (hereafter, “Component A3) of (A1) an epoxy compound having the repeating unit expressed by the following general formula (1a) and the repeating unit expressed by the following general formula (1b) (hereafter, “Component A1”) and (A2) an unsaturated carboxyl compound having a carbon-carbon double bond and a carboxyl group (hereafter, “Component A2”), with (A4) an acid anhydride (hereafter, “Component A4”). In the following formulae, R¹, R², R³ are identical to the above:

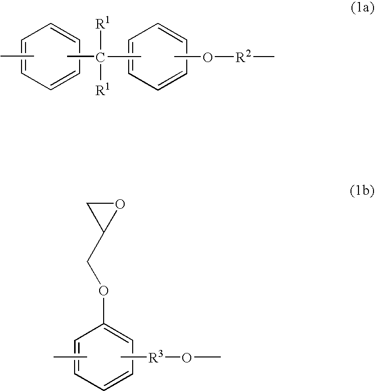

In the repeating unit expressed by the general formula (1a) (hereafter, “unit 1a”) and the repeating unit expressed by the general formula (1b) (hereafter, “unit 1b”), R² and R³ are respectively, preferably an alkylene group having 1-6 carbon atoms, more preferably an alkylene group having 1-3 carbon atoms, and still more preferably a methylene group. Component Al which has these repeating units can be obtained from a phenol novolak epoxy resin, a bisphenol resin (bisphenol A, bisphenol F, bisphenol Z or halides thereof) or epihalohydrine by methods known in the art.

Component Al may be an alternate copolymer, a block copolymer or a random copolymer of unit 1a and unit 1b, but is preferably an alternate copolymer or a block copolymer.

Component A1 is preferably for example a polymer expressed by the following general formula (2), this polymer comprising the aforesaid unit 1a and unit 1b. The polymer may be terminated by unit 1a or unit 1b, and if it is terminated by unit 1a, the hydroxyl group in bisphenol may be replaced by a substituent such as a glycidyl group:

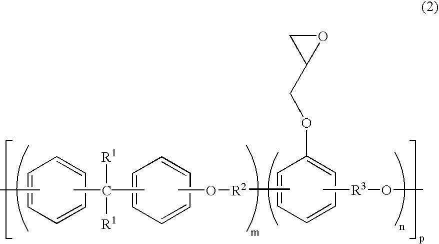

R¹, R², R³ are identical to those in the above formulae. m and n are positive integers such that m+n is an integer from 2-50, but preferably an integer from 2-30, and more preferably an integer from 2-20. p is a positive integer, but preferably an integer from 1-25, more preferably an integer from 1-15, and still more preferably an integer from 1-10.

Component A1 is preferably a compound expressed by the following general formula (4), but more preferably a compound expressed by the following general formula (5). In the following general formulae (4) and (5), R¹ and R² are identical to the above, R is a hydrogen atom or glycidyl group, and y is an integer from 1-50. For example, in the following general formula (5), compounds wherein R²¹ is a glycidyl group can be commercially obtained as the YDPF series (Toto Kasei). By using these epoxy compounds as Component Al, resolution, adhesion, PCT resistance, electrical corrosion resistance, heat-resisting property, and thermal impact resistance can be further enhanced:

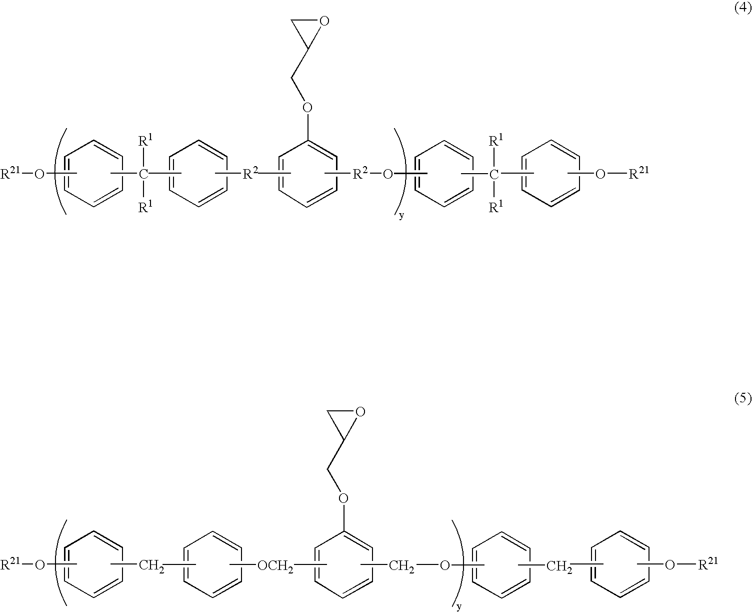

Component A2 is a compound having a carbon-carbon double bond and a carboxyl group. This Component A2 is used to introduce a carbon-carbon double bond into the molecule and produce a hydroxyl group by reacting with Component A1.

It is sufficient if the reaction of Component Al and Component A2 occurs at least between the epoxy group in Component A1 and the carboxyl group in Component A2. Component A3 obtained by this reaction therefore has a carbon-carbon double bond and a hydroxyl group in the molecule.

More specifically, Component A2 is preferably the compound expressed by the following general formula (3):

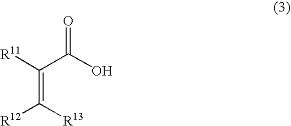

In the formula, R¹¹ is a hydrogen atom or an alkyl group, and R¹², R¹³ are respectively and independently a hydrogen atom, alkyl group, aryl group, styryl group, furfuryl group or cyano group. In this case, as the alkyl group, methyl is more preferred.

Examples of the compound expressed by the aforesaid general formula (3) are (meth)acrylic acid, β-furfuryl acrylic acid, β-styryl acrylate, cinnamic acid, crotonic acid and α-cyanocinnamic acid. The photosensitive resin composition may further contain a dimer of the compound expressed by the aforesaid general formula (3), and this dimer may for example be the dimer of acrylic acid. (Meth)acrylic acid means acrylic acid or methacrylic acid, and this is identical for compounds such as (meth)acrylates or functional groups.

Component A2 expressed by the aforesaid general formula (3) is preferably (meth)acrylic acid. If (meth)acrylic acid is used as Component A2, the reaction with Component A1 proceeds well. The obtained Component A then efficiently undergoes a curing reaction, and a tougher cured material can be obtained.

An unsaturated dibasic acid monoester can also be used as Component A2. This monoester is a compound wherein one of the two carboxyl groups of the dibasic acid is esterified by a compound having a double bond.

This monoester is preferably a monoester formed by reacting an acid anhydride and a (meth)acrylate compound having a hydroxyl group, or a monoester formed by reacting an acid anhydride and a (meth)acrylate compound having a glycidyl group, but the former monoester is more preferred.

Examples of acid anhydrides for synthesizing the unsaturated dibasic acid monoester are succinic anhydride, maleic anhydride, tetrahydromaleic anhydride, phthalic anhydride, methyl tetrahydrophthalic anhydride, ethyl tetrahydrophthalic anhydride, hexahydrophthalic anhydride, methyl hexahydrophthalic anhydride, ethyl hexahydrophthalic anhydride and anhydrous itaconic acid.

Examples of (meth)acrylate compounds having a hydroxyl group are hydroxyethyl(meth)acrylate hydroxypropyl(meth)acrylate, hydroxybutyl(meth)acrylate, polyethylene glycol mono(meth)acrylate, trimethylolpropanedi(meth)acrylate, pentaerythritol(meth)acrylate and dipentaerythritolpenta(meth)acrylate. An example of a (meth)acrylate compound having a glycidyl group is glycidyl (meth)acrylate.

Component A3 is obtained by making the aforesaid Component A1 and Component A2 mentioned react. When Component A1 and Component A2 are reacted, Component A2 may be reacted with all the epoxy groups of Component A1, or the component ratio may be changed and it may be reacted with only some of the epoxy groups in Component A1.

In this reaction, it is preferred that 0.8-1.10 Eq and more preferred that 0.9-1.0 Eq of the carboxyl groups of Component A2 are reacted with 1 Eq of the carboxyl groups of Component A1.

Component A1 and Component A2 can be reacted together after dissolving in an organic solvent. Examples of organic solvents are ketones such as methylethyl ketone or cyclohexanone; aromatic hydrocarbons such as toluene, xylene or tetramethylbenzene; glycol ethers such as methyl cellosolve, butyl cellosolve, methyl carbitol, butyl carbitol, propylene glycol monomethyl ether, dipropylene glycol monoethyl ether, dipropylene glycol diethyl ether or triethylene glycol monoethyl ether; esters such as ethyl acetate, butyl acetate, butyl cellosolve acetate or carbitol acetate; aliphatic hydrocarbons such as octane or decane; and petroleum solvents such as petroleum ether, petroleum naphtha, hydrogenated petroleum naphtha or solvent naphtha.

It is more preferred that a catalyst is added to the aforesaid reaction. Examples of catalysts are triethylamine, benzylmethylamine, methyltriethylammonium chloride, benzyltrimethylammonium bromide, benzyltrimethylammonium iodide and triphenylphosphine. The catalyst addition amount is preferably 0.1 to 10 wt parts to a total of 100 wt parts of Component A1 and Component A2. By adding such a catalyst, the reaction of Component A1 and Component A2 may be accomplished in a shorter time.

In addition, it is still more preferred to add a polymerization inhibitor to the aforesaid reaction. Examples of polymerization inhibitors are hydroquinone, methyl hydroquinone, hydroquinone monomethyl ether, catechol and pyrogallol. The polymerization inhibitor addition amount is preferably 0.01 to 1 wt parts to a total of 100 wt parts of Component A1 and Component A2. By adding the polymerization inhibitor, the polymerization reaction of Component A1 itself which is an undesirable side reaction can be reduced, and the reaction of Component A1 and Component A2 proceeds more efficiently. The reaction temperature of this reaction is preferably 60-150° C., but more preferably 80-120° C.

In the reaction of Component A1 and Component A2, a polybasic acid anhydride having three or more carboxyl groups, such as anhydrous trimellitic acid, anhydrous pyromellitic acid, benzophenone tetracarboxylic anhydride or biphenyl tetracarboxylic anhydride, may also be used in addition to the aforesaid compounds as Component A2.

Component A3 obtained by the reaction of Component A1 and Component A2 is preferably a polymer having a repeating unit expressed by the following general formula (6). In the following formula, R¹, R², R³, R¹¹, R¹², R¹³, m, n and p have identical meanings to the above:

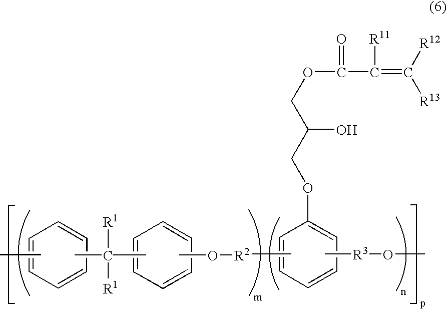

Component A4 which reacts with Component A3 is an acid anhydride, and is used for the purpose of introducing a carboxyl group into Component A. It is sufficient if the reaction between Component A3 and Component A4 takes place at least between the hydroxyl group in Component A3 and Component A4.

It is thought that Component A obtained by this reaction comes to have a carboxyl group in the molecule based on the reaction of Component A3 and Component A4, and a carbon-carbon double bond in the molecule based on the reaction of Component A1 and Component A2.

Examples of Component A4 are succinic anhydride, maleic anhydride, tetrahydromaleic anhydride, phthalic anhydride, methyl tetrahydrophthalic anhydride, ethyl tetrahydrophthalic anhydride, hexahydrophthalic anhydride, methyl hexahydrophthalic anhydride, ethyl hexahydrophthalic anhydride and anhydrous itaconic acid. Component A4 may be identical to the acid anhydride used in the reaction for obtaining an unsaturated dibasic acid monoester, or it may be different.

The acid number of Component A obtained by the aforesaid reaction is preferably 30-150 mgKOH/g, but more preferably 50-120 mgKOH/g. If the acid number of Component A is less than 30 mgKOH/g, the solubility in an alkali solution of uncured parts of the obtained photosensitive resin composition falls, and there is a tendency for developing properties to worsen when the resist pattern is formed. On the other hand, if the acid number of Component A exceeds 150 mgKOH/g, electrical properties after curing the obtained photosensitive resin composition decline.

In the reaction between Component A3 and Component A4, it is preferred that there are 0.1-1.0 Eq to 1 Eq, more preferred that there are 0.3-0.9 Eq, and still more preferred that there are 0.4-0.7 Eq. of anhydrous carboxyl groups (—CO—O—CO—) in Component A4, relative to 1 Eq of hydroxyl groups in Component A3. If the equivalence ratio of Component A3 and Component A4 lies within the aforesaid range, the acid number of Component A above will lie within the aforesaid suitable range. The reaction temperature in this reaction should preferably be 60-120° C.

The polymer which is suitable as Component A thus obtained is a polymer expressed by the following general formula (7). In the following formula, R¹, R², R³, R¹¹, R¹², R¹³, m, n, and p are identical to the above, and X is ethylene group, ethynylene group, substituted ethylene group or substituted ethynylene group. When there are plural substituent groups, the plural substituent groups may be connected together. X is an acid anhydride residue such as succinic anhydride, maleic anhydride, tetrahydromaleic anhydride, phthalic anhydride, methyl tetrahydrophthalic anhydride, ethyl tetrahydrophthalic anhydride, hexahydrophthalic anhydride, methyl hexahydrophthalic anhydride, ethyl hexahydrophthalic anhydride or anhydrous itaconic acid. Here, an acid anhydride residue means a divalent group wherein an anhydrous carboxyl group is excluded from the above acid anhydride:

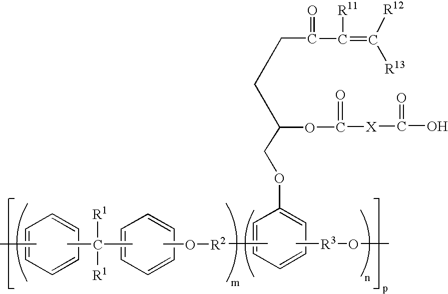

(Component B)

The photopolymerizable monomer which is Component B is a component which can undergo photopolymerization when irradiated by the activation light, and can form a crosslinked structure by undergoing a polymerization reaction with Component A. By dissolving Component A, Component B reduces the viscosity of the photosensitive resin composition, makes for greater convenience such as easier handling, and functions also as what is known as a reactive diluent.

Examples of Component B are (2-hydroxyethyl(meth)acrylate, trimethylolpropane tri(meth)acrylate, pentaerythritol tri(meth)acrylate, dipentaerythritol hexa(meth)acrylate, N,N-dimethyl(meth)acrylate or N-methylol(meth)acrylamide, polyethylene glycol, polypropylene glycol, the polyethylene glycol of bisphenol A, propylene glycol, (meth)acrylates of tris(2-hydroxyethyl)isocyanuric acid, (meth)acrylates of glycidyl ethers such as triglycidyl isocyanate, and diallyl phthalate. By adding these compounds as Component B, photosensitivity or crosslinking density can be enhanced, and the obtained cured material can be made still tougher.

(Component C)

The radical photopolymerization initiator which is Component C is a component which produces an active radical species by exposure to the activation light, and starts the radical polymerization reaction of Component A and Component B. Examples of Component C are benzoins such as benzoin methyl ether or benzoin isopropyl ether; acetophenones such as acetophenone, 2,2-dimethoxy-2-phenylacetophenone, 2,2-diethoxy-2-phenylacetophenone, 1,1-dichloroacetophenone, 1-hydroxycyclohexylphenylketone, 2-methyl-1-[(4-methylthio)phenyl]-2-morpholinopropane-1-one, 2,2-diethoxyacetophenone or N,N-dimethylaminoacetophenone; anthraquinones such as 2-methyl anthraquinone, 2-ethyl anthraquinone, 2-tert-butylanthraquinone, 1-chloroanthraquinone, 2-amylanthraquinone or 2-aminoanthraquinone; thioxanthones such as 2,4-dimethylthioxanthone, 2,4-diethylthioxanthone, 2-chorothioxanthone or 2,4-diisopropylthioxanthone; ketals such as acetophenone dimethylketal or benzyl methyl ketal; benzophenones such as benzophenone, methyl benzophenone, 4,4′-dichlorobenzophenone, 4,4′-bis(diethylamino)benzophenone, N,N′-tetramethyl-4,4′-diaminobenzophenone (Michler's ketone) or 4-benzoyl-4′-methyldiphenylsulfide; 2,4,5-triarylimidazole dimers such as 2-(o-chlorophenyl)-4,5-diphenylimidazole dimer, 2-(o-chlorophenyl)-4,5-di(m-methoxyphenylimidazole dimer), 2-(o-fluorophenyl)-4,5-diphenylimidazole dimer, 2-(o-methoxyphenyl)-4,5-diphenylimidazole dimer, 2-(p-methoxyphenyl)-4,5-diphenylimidazole dimer, 2,4-di(p-methoxyphenyl)-5-phenylimidazole dimer or 2-(2,4-dimethoxyphenyl)-4,5-diphenylimidazole dimer; acridine derivatives such as 9-phenylacridine or 1,7-bis-(9,9-acridinyl)heptane; and 2,4,6-trimethylbenzoyldiphenylphosphine oxide. These may be used alone, or two or more may be used together.

In the photosensitive resin composition, an auxiliary agent of photoinitiator can also be used together with the aforesaid Component C. The auxiliary agent of photoinitiator may be a tertiary amine such as ethyl N,N-dimethylamino benzoate ester, isoamyl N,N-dimethylamino benzoate ester, pentyl-4-dimethylaminobenzoate, dimethylethanolamine, triethylamine or triethanolamine. These may be used alone, or two or more may be used together. If a auxiliary agent of photoinitiator is used, its amount is preferably 0.1 to wt % on the basis of the total weight of the photosensitive resin composition.

(Component D)

Component D is a curing agent which has reactivity with a functional group of Component A and/or Component B. Component A has a carboxyl group as mentioned above, and may have functional groups other than carboxyl groups such as a hydroxyl group in the molecule depending on the case. Component B has various functional groups (for example, a carboxyl group, a hydroxyl group or an amino group) depending on the chemical moeity. Therefore, Component D is a compound having a functional group which can react with these functional groups. For example, Component D may be a curing agent having an epoxy group and/or an amino group, and depending on this curing agent, a reaction may occur with a carboxyl group in Component A or Component C. Hence, the functional group which Component D should have can be suitably determined according to the chemical structure of Component A or Component B.

Component D is preferably a multi-functional curing agent having two or more functional groups capable of reacting with a functional group of Component A and/or Component B.

When using a compound having an epoxy group as Component D, it is more preferred that this compound has a different structure from Component A mentioned above. Examples of this epoxy compound are bisphenol A epoxy resin, bisphenol F epoxy resin, hydrogenated bisphenol A epoxy resin, brominated bisphenol A epoxy resin, Novolak epoxy resin, bisphenol S epoxy resin, triglycidyl isocyanate and bixylenol epoxy resin.

The epoxy compound may further include other epoxy compounds different from those mentioned above. Examples of these other epoxy compounds are salicylaldehyde epoxy resin, epoxy group-containing polyamide resins, epoxy group-containing polyamidoimide resins, biphenyl epoxy resins such as YX4000 (Japan Epoxy Resin), dichloroepoxy resins such as Epiclon HP7200 (Dai Nippon Ink Chemical Industries), Epiclon 430 (Dai Nippon Ink Chemical Industries), glycydyl amine epoxy resins such as ELM100, ELM120, ELM434 (Sumitomo Chemical Industries), glycydyl ester epoxy resins such as Denacol EX-721 (Nagase Chemical Industries), heterocyclic epoxy resins such as Epiclon HP-4032 (Dai Nippon Ink Chemical Industries) or tris(2,3-epoxypropyl)isocyanurate (Nissan Chemical Industries), and modified bisphenol S epoxy resins such as EBPS-300 (Toto Chemicals) and EXA-4004 (Dai Nippon Ink Chemical Industries).

When these epoxy compounds are further contained in the photosensitive resin composition, their blending amount is preferably 0.01 to 20 wt parts, but more preferably 0.1 to 10 wt parts, relative to a total weight of 100 wt parts of the photosensitive resin composition.

A compound other than the epoxy compounds mentioned above can also be contained as Component D. Examples of this compound are melamine compounds such as triaminotriazine, hexamethoxymelamine and hexabutoxymelamine, urea compounds such as dimethylolurea, and oxazoline compounds.

When using an epoxy resin as Component D, a catalyst which promotes the reaction of the epoxy resin may be further added. Examples of this catalyst are imidazole catalysts such as 2-ethyl-4-methylimidazole (2E4MZ) or 2,4-diamino-6-[2′-undecylimidazole-(1)]-ethyl-S-triazine (C11Z-A) (both from Shikoku Chemicals); tertiary amine compounds such as benzylmethylamine; and Lewis acids such as boron trifluoride.

(Elastomer)

It is more convenient if the photosensitive resin composition of the invention further contains an elastomer. By containing an elastomer in the photosensitive resin composition, when the composition is used as a solder resist, adhesion to the conductor layer can be further enhanced, and it is then possible to improve the heat-resisting property, flexibility and toughness after curing the photosensitive resin composition.

The elastomer contained in the photosensitive resin composition may be a styrene elastomer, an olefin elastomer, a urethane elastomer, a polyester elastomer, a polyamide elastomer, an acrylic elastomer or a silicone elastomer.

The styrene elastomer may for example be a styrene-butadiene-styrene block copolymer, styrene-isoprene-styrene block copolymer, styrene-ethylene-butylene-styrene block copolymer or styrene-ethylene-propylene-styrene block copolymer. The styrene component in the styrene elastomer may be a styrene derivative other than styrene, such as (α-methylstyrene, 3-methylstyrene, 4-propylstyrene or 4-cyclohexylstyrene.

Commercially available styrene elastomers are Tufprene, Solprene T, Asaprene T, Tuftec (Asahi Chemical Industries), Elastomer AR (Aron Kasei), Krayton G, Califlex (Shell Japan), JSR-TR, TSR-SIS, Dainalon (Nippon Synthetic Rubber), Denka STR (Denki Kagaku), Quintac (Nippon Zeon), TPE-SB Series (Sumitomo Chemicals), Rubberon (Mitsubishi Chemicals), Septon, Hybrar (Kuraray), Sumiflex (Sumitomo Bakelite), Leostomer, and Actimer (both from Riken Vinyl Industries).

Examples of olefin elastomers are or monopolymers or copolymers of α-olefins having 2-20 carbon atoms such as ethylene, propylene, 1-butene, 1-hexene or 4-methyl-pentene; ethylene-propylene copolymer (EPR); ethylene -propylene-diene copolymer (EPDM); copolymers of dienes having 2-20 carbon atoms such as dicyclopentadiene, 1,4-hexadiene, cyclooctadiene, methylene norbornene, ethylidene norbornene, butadiene and isoprene with an α-olefin; carboxy-modified NBR which is a copolymer of methacrylic acid with butadiene-acrylonitrile copolymer; ethylene-a-olefin copolymer rubber; ethylene-α-olefin unconjugated diene copolymer rubber; propylene-α-olefin copolymer rubber; and butene-α-olefin copolymer rubber.

Commercially available olefin elastomers are Milastomer (Mitsui Petrochemicals), EXACT (Exxon Chemicals), ENGAGE (Dow Chemicals), DYNABON HSBR which is a hydrogenated styrene-butadiene copolymer, NBR series which are butadiene-acrylonitrile copolymers, and the XER series which are biterminal carboxy-modified butadiene-acrylonitrile copolymers having a crosslinking point (these from Dai Nippon Ink Chemical Industries).

Urethane elastomers comprise a hard segment of a short chain diol and diisocyanate, and a soft segment of a long chain diol and diisocyanate. Examples of long chain diols are polypropylene glycol, polytetramethylene oxide, poly(1,4-butylene adipate), poly(ethylene-1,4-butylene adipate), polycaprolactone, poly(1,6-hexylene carbonate) and poly(1,6-hexylene neopentylene adipate). The number average molecular weight of the long chain diol is preferably 500-10000. Examples of short chain diols are ethylene glycol, propylene glycol, 1,4-butanediol and bisphenol A. The number average molecular weight of the short chain diol is preferably 48-500. The aforesaid urethane elastomer can be commercially obtained as PANDEX T-2185 or T-2983N (Dai Nippon Ink Chemical Industries).

Polyester elastomers are elastomers obtained by the polycondensation of a dicarboxylic acid or its derivative with a diol compound or its derivative. Examples of dicarboxylic acids are terephthalic acid, isophthalic acid, naphthalene dicarboxylic acid and aromatic dicarboxylic acids wherein these rings are substituted by methyl groups, ethyl groups or phenyl groups; aliphatic dicarboxylic acids having 2-20 carbon atoms such as adipic acid, sebacic acid or dodecane dicarboxylic acid; and alicyclic dicarboxylic acids such as cyclohexane dicarboxylic acid. One, two or more of these compounds may be used. Examples of diol compounds are aliphatic or alicyclic diols, such as ethylene glycol, 1,3-propanediol, 1,4-butanediol, 1,6-hexane diol, 1,10-decane diol and 1,4-cyclohexane diol; bisphenol A, bis-(4-hydroxyphenyl)-methane, bis-(4-hydroxy-3-methylphenyl)-propane, and resorcinol One, two or more of these compounds may be used. A multi-block copolymer having an aromatic polyester (for example, polybutylene terephthalate) as the hard segment component, and an aliphatic polyester (for example, polytetramethylene glycol) as the soft segment component, can be used. Commercially available polyester elastomers are Hitrel (Dupont-Toray), Pelprene (Toyo Boseki) and Espel (Hitachi Chemical Industries).

Polyamide elastomers are elastomers comprising a hard segment of polyamide, and a soft segment of polyether or polyester, and may be roughly divided into two kinds such as a polyether block amide type and a polyether ester block amide type. Examples of polyamides are polyamide 6, polyamide 11 and polyamide 12, and examples of polyethers are polyoxyethylene, polyoxypropylene and polytetramethylene glycol.

Commercially available polyamide elastomers are UBE polyamide elastomers (Ube Kosan), diamides (Daicell Fuels), PEBAX (Toray), Grilon ELY (EMS Japan), Novamid (Mitsubishi Chemicals) and Grilux (Dai Nippon Ink Chemical Industries).

Acrylic elastomers are elastomers obtained by copolymerization of an acrylic ester such as ethyl acrylate, butyl acrylate, methoxyethyl acrylate and ethoxyethyl acrylate, with a monomer having an epoxy group, such as glycydyl methacrylate and allyl glycidyl ether, and/or a vinyl monomer such as acrylonitrile or ethylene. Examples of acrylic elastomers are acrylonitrile-butyl acrylate copolymer, acrylonitrile-butyl acrylate-ethyl acrylate copolymer, and acrylonitrile-butyl acrylate-glycydyl methacrylate copolymer.

Silicone elastomers are elastomers which have an organopolysiloxane as their main component, examples being polydimethylsiloxane, polymethylphenylsiloxane and polydiphenylsiloxane silicone elastomers. An elastomer wherein the organopolysiloxane has been modified by a vinyl group or an alkoxy group may also be used. Commercially available silicone elastomers are the KE series (Shin-Etsu Chemicals), SE series, CY series and SH series (Dow Corning Toray Silicones).

In addition to the above elastomers, the product of kneading granules of the above elastomers with a rubber-modified epoxy resin or epoxy resin, may also be used. In a rubber-modified epoxy resin, at least part of the epoxy groups of the epoxy resin are modified by biterminal carboxy-modified butadiene-acrylonitrile copolymer, or terminal amino-modified silicone rubber.

As the elastomer, a biterminal carboxy group-modified butadiene acrylonitrile copolymer, or Espel (Espel 1612, Espel 1620, Hitachi Chemical Industries) which is a polyester elastomer, may also be used.

(Phenoxy Resin)

The photosensitive resin composition more preferably further contains a phenoxy resin. By further containing a phenoxy resin, not only is adhesion to the conductor layer of the printed circuit board improved when the obtained photosensitive resin composition is used as a solder resist, but the flexibility of the cured product is also enhanced. The phenoxy resin may for example be the phenoxy resin having a repeating unit expressed by the following formula (8):

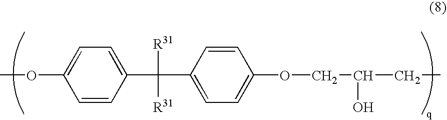

In the formula, R³¹ is a hydrogen atom or a methyl group, and q is an integer equal to 30 or more. The phenoxy resin may contain a structural unit wherein R³¹ is a hydrogen atom, a structural unit wherein R³¹ is a methyl group, or both a structural unit wherein R³¹ is a hydrogen atom and a structural unit wherein R³¹ is a methyl group.

Commercially available phenoxy resins wherein R³¹ is a methyl group are YP-50, YP-50S, YP-55 (Toto Kasei), Epicoat 1256 (Japan Epoxy Resins), PKHC, PKHH and PKHB (InChem Corp.).

Commercially available phenoxy resins containing both a structural unit wherein R³¹ is a hydrogen atom and a structural unit wherein R³¹ is a methyl group, are YP-70, FX239 (Toto Kasei), Epicoat 4250 and Epicoat 4275 (Japan Epoxy Resins).

These phenoxy resins may be used alone, or two or more may be used together. The weight average molecular weight of the phenoxy resin is preferably 20,000-100,000, but more preferably 30,000-80,000. By using a phenoxy resin having a weight average molecular weight within the above range, the flexibility of the cured product of the photosensitive resin composition can be enhanced. The weight average molecular weight can be measured by gel permeation chromatography (GPC), and can be found by conversion from a calibration curve using a reference polystyrene.

(Block Isocyanate)

The photosensitive resin composition may further contain a block isocyanate. By containing a block isocyanate, the curing properties of the cured product of the photosensitive resin composition are further enhanced.

The block isocyanate is a compound obtained by adding a blocking agent to a polyisocyanate compound. Examples of polyisocyanate compounds are polyisocyanate compounds such as tolylene diisocyanate, xylylene diisocyanate, phenylene diisocyanate, naphthylene diisocyanate, bis(isocyanate methyl)cyclohexane, tetramethylene diisocyanate, hexamethylene diisocyanate, methylene diisocyanate, trimethyl hexamethylene diisocyanate and isophorone diisocyanate, or adducts, biurets or isocyanurates thereof.

Examples of blocking agents are phenolic blocking agents such as phenol, cresol, xylenol, chlorophenol or ethyl phenol; lactam blocking agents such as ε-caprolactam, δ-valerolactam, γ-butyrolactam or β-propiolactam; active methylenic blocking agents such as ethyl acetate or acetylactone; alcoholic blocking agents such as methanol, ethanol, propanol, butanol, amyl alcohol, ethylene glycol monomethyl ether, ethylene glycol monoethyl ether, ethylene glycol monobutyl ether, diethylene glycol monomethyl ether, propylene glycol monomethyl ether, benzyl ether, methyl glycolate, butyl glycolate, diacetone alcohol, methyl lactate or ethyl lactate; oxime blocking agents such as formaldehyde oxime, acetaldoxime, acetoxime, methyl ethyl ketoxime, diacetyl mono-oxime or cyclohexane oxime; mercaptan blocking agents such as butyl mercaptan, hexyl mercaptan, tert-butyl mercaptan, thiophenol, methyl thiophenol or ethyl thiophenol; acid amide blocking agents such as acetic acid amide or benzoamide; imide blocking agents such as succinic acid imide or maleic acid imide; amine blocking agents such as xylidene, aniline, butylamine or dibutylamine; imidazole blocking agents such as imidazole or 2-ethylimidazole; and imine blocking agents such as methylene imine or propylene imine.

The blocking isocyanate comprising the aforesaid polyisocyanate and blocking agent may be used alone, or two or more may be used together.

(Non-Elastomer-like Polymer of Polymerizable Compound Containing a Carbon-Carbon Double Bond)

The photosensitive resin composition may further contain a non-elastomer-like polymer of a polymerizable compound having a carbon-carbon double bond. If the photosensitive resin composition contains this type of polymer, a cured product having still higher strength can be obtained, and adhesion to the circuit-forming substrate is further enhanced. In this context, “non-elastomer-like polymer” means a polymer not having the properties of “elastomers defined by JIS (Japanese Industrial Standards) K6200”, i.e., a polymer substance which does not show rubber-like elasticity at room temperature. This type of non-elastomer-like polymer may be obtained by suitably selecting the polymerizable compound having a carbon-carbon double bond used for polymerization. For example, if the non-elastomer-like polymer is a copolymer, the proportion of polymerizable compound having a carbon-carbon double bond may be designed so that the obtained polymer does not have elastomer-like properties. The non-elastomer-like polymer is preferably a non-elastomer-like polymer obtained by polymerizing a polymerizable compound having a (meth)acryloyl group.

The polymerizable compound used to form this polymer may for example be the compound obtained by reacting an α, β-unsaturated carboxylic acid with a polyalcohol such as polyethylene glycol di(meth)acrylate (having 2-14 ethylene groups), trimethylol propane di(meth)acrylate, trimethylol propane tri(meth)acrylate, trimethylol propane ethoxytri(meth)acrylate, trimethylolpropane propoxytri(meth)acrylate, tetramethylolmethane tri(meth)acrylate, tetramethylolmethane tetra(meth)acrylate, polypropylene glycol di(meth)acrylate (having 2-14 propylene groups), dipentaerythritolpenta(meth)acrylate or dipentaerythritol hexa(meth)acrylate; the compound obtained by adding a bisphenol A dioxyethylene di(meth)acrylate such as bisphenol A dioxyethylene di(meth)acrylate, bisphenol A trioxyethylene di(meth)acrylate or bisphenol A decaoxyethylene di(meth)acrylate, or a glycidyl group-containing compound such as trimethylol propanetriglycidyl ether triacrylate or bisphenol A diglycidyl ether acrylate to an α, β-unsaturated carboxylic acid; the esterified product of a polycarboxylic acid such as phthalic anhydride with a substance having a hydroxyl group and a carbon-carbon double bond such as β-hydroxyethyl(meth)acrylate; an alkyl ester of (meth)acrylic acid such as (meth)acrylic acid methyl ester, (meth)acrylic acid ethyl ester, (meth)acrylic acid butyl ester or (meth)acrylic acid 2-ethylhexyl ester; the reaction product of tolylene diisocyanate and 2-hydroxyethyl(meth)acrylic acid ester; and a urethane(meth) acrylate such as the reaction product of trimethylhexamethylene diisocyanate, cyclohexane dimethanol and 2-hydroxyethyl(meth)acrylic acid ester.

(Other Components)

The photosensitive resin composition may further contain other components in addition to the above. An example of such additional components is a heat-curing accelerator. Examples of heat-curing accelerators are aromatic amines such as boron trifluoride-amine complex, dicyandiamides, organic acid hydrazides, diaminomaleonitrile, diaminodiphenylmethane, metaphenylene diamine, metaxylene diamine, diaminodiphenyl sulfone or hardener HT 972 (Ciba Geigy); aromatic acid anhydrides such as phthalic anhydride trimellitic anhydride, ethylene glycol bis(anhydrotrimellitate), glycerol tris(anhydrotrimellitate) or benzophenone tetracarboxylic acid anhydride; aliphatic acid anhydrides such as maleic anhydride or tetrahydrophthalic anhydride; acetylacetone metal salts such as zinc acetylacetonate; enamines, tin octylate, quartenary phosphonium salts or tertiary phosphines such as triphenylphosphine; phosphonium salts such as tri-n-butyl(2,5-dihydroxyphenyl)phosphonium bromide or hexadecyltributylphosphonium chloride; quartenary ammonium salts such as benzyltrimethlyammonium chloride or phenyltributylammonium chloride; borates such as diphenyliodinium tetrafluoroborate; antimonates such as triphenylsulfonium hexafluoroantimonate; tertiary amines such as dimethylbenzylamine, 1,8-diazabicyclo[5.4.0]undecene, m-aminophenol, 2,4,6-tris(dimethylaminophenol) or tetramethyl guanidine; and imidazoles such as 2-ethyl-4-methylimidazole, 2-methylimidazole, 1-benzyl-2-methylimidazole, 2-phenylimidazole or 2-phenyl-4-methyl-5-hydroxymethylimidazole. These may be used alone, or two or more may be used together.

In addition, colorants known in the art such as phthalocyanine blue, phthalocyanine green, iodine green, bis-azo yellow, crystal violet, titanium oxide, carbon black or naphthalene black, polymerization inhibitors such as hydroquinone, methyl hydroquinone, hydroquinone monomethyl ether, catechol or pyrogallol, viscosity enhancers such as bentone or montmorillonite, silicone, fluoride or vinyl resin anti-foaming agents, silane coupling agents, and auxiliary agent of flame retardants such as antimony trioxide may also be used. These may be used alone, or two or more may be used together.

Still further, an organic solvent may be added. Examples of organic solvents are ketones such as methyl ethyl ketone or cyclohexanone; aromatic hydrocarbons such as toluene, xylene or tetramethylbenzene; glycol ethers such as methyl cellosolve, butyl cellosolve, methyl carbitol, butyl carbitol, propylene glycol monomethyl ether, dipropylene glycol monoethyl ether, dipropylene glycol diethyl ether or triethylene glycol monoethyl ether; esters such as ethyl acetate, butyl acetate, butyl cellosolve acetate or carbitol acetate; aliphatic hydrocarbons such as octane or decane; and petroleum solvents such as petroleum ether, petroleum naphtha, hydrogenated petroleum naphtha or solvent naphtha. By adding these organic solvents to the photosensitive resin composition to dissolve it, ease of handling is improved.

(Blending Amount of Components)

The blending amount of Component A is preferably 30-80 wt parts, but more preferably 40-60 wt parts relative to a total of 100 wt parts of the photosensitive resin composition. If the blending amount of Component A is less than 30 wt parts, coatability tends to decline when the composition is used as a printing ink, and if it exceeds 80 wt parts, the heat resistance of the cured product tends to decrease.

The blending amount of Component B is preferably 0.5-30 wt parts, but more preferably 3-15 wt parts relative to a total of 100 wt parts of the photosensitive resin composition. If the blending amount of Component B is less than 0.5 wt parts, the unexposed part is also dissolved when the exposed part is removed by an alkali solution so that the resolution of the resist pattern decreases, and if it exceeds 30 wt parts, the heat-resistance of the cured product tends to decrease.

The blending amount of Component C is preferably 0.5-20 wt parts, but more preferably 2-15 wt parts and still more preferably 1-10 wt parts relative to a total of 100 wt parts of the photosensitive resin composition. If the blending amount of Component C is less than 0.5 wt parts, the unexposed part is also dissolved when the exposed part is removed by an alkali solution so that the resolution of the resist pattern decreases, and if it exceeds 20 wt parts, the heat-resistance of the cured product tends to decrease.

The blending amount of Component D is preferably 20 2-50 wt parts, but more preferably 10-40 wt parts relative to a total of 100 wt parts of the photosensitive resin composition. If the blending amount of Component D is less than 2 wt parts, the heat-resistance of the cured product tends to decrease, and if it exceeds 50 wt parts, resolution tend to decrease.

If the photosensitive resin composition further contains an elastomer, the blending amount of the elastomer is preferably 0.5-20 wt parts, but more preferably 1.0-10 wt parts relative to 100 wt parts of Component A.

If the composition further contains a phenoxy resin, the blending amount of the phenoxy resin is preferably 0.5-10 wt parts, but more preferably 1.0-8.0 wt parts relative to 100 wt parts of Component A.

If the composition further contains a block isocyanate, its blending amount is preferably 0.5-10 wt parts, but more preferably 1.0-8.0 wt parts relative to 100 wt parts of Component A.

(Photosensitive Element)

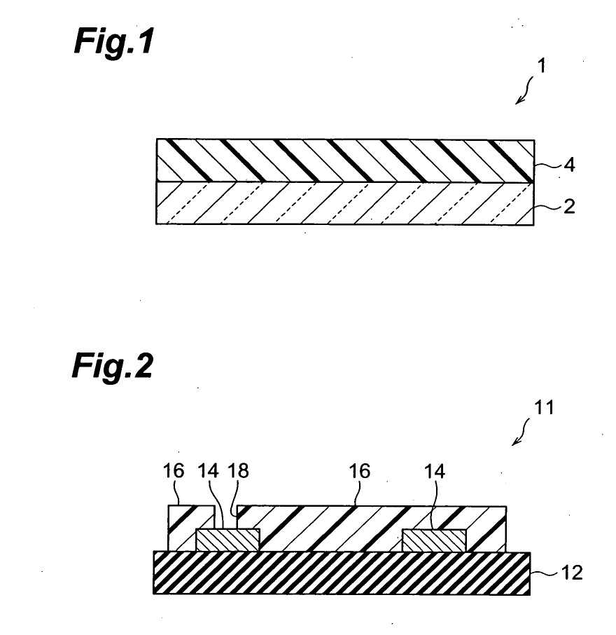

FIG. 1 is a schematic cross-sectional view showing one embodiment of a photosensitive element. A photosensitive element 1 comprises a support 2, and a photosensitive resin composition layer 4 of the photosensitive resin composition of the invention formed on the support 2. The photosensitive element 1 may be obtained for example by dissolving the photosensitive resin composition of the invention in an organic solvent, coating the obtained solution on the support 2 of polyolefin, polyvinyl chloride or polyester by a method known in the art such as a roll coater, comma coater, gravure coater, air knife coater, die coater or bar coater, heating and drying. A protective film covering this layer may be further provided on the formed photosensitive resin composition layer 4.

(Resist Pattern-Forming Method)

In the resist pattern-forming method of the invention, the photosensitive resin composition layer of the photosensitive resin composition of the invention is laminated on an insulating substrate of a laminated substrate, the laminated substrate comprising the insulating substrate and a conductor layer having a circuit pattern formed on the insulating substrate, so as to cover the conducting layer. A predetermined part of the photosensitive resin composition layer is then irradiated by an activation light to form an exposed part, and parts other than the exposed part are then removed.

In this lamination method, the photosensitive resin composition of the invention may be for example kneaded or mixed by a roll mill or bead mill, or dissolved in a solvent, coated on the insulating substrate by a method known in the art such as screen printing, spraying, roll coating, curtain coating or electrostatic coating to form a film thickness of 10-200 μm, and the film then dried at 60-110° C. Alternatively, the photosensitive resin composition layer in the photosensitive element of the invention may be laminated by compressing it on the insulating substrate while heating. Therefore, in the photosensitive resin composition layer laminated on the substrate, if the photosensitive resin composition contains a volatile component, the component left after most of the solvent has eliminated becomes the main component.

After lamination has been completed in this manner, a predetermined part of the photosensitive resin composition layer is irradiated by the activation light to form an exposed part. The exposed part may be formed for example by image-wise irradiation of the activation light through a negative or positive mask pattern known as an art work. At this time, the mask may be brought directly in contact with the photosensitive resin composition, or may be brought into contact via a transparent film.

The activation light source may be a light source known in the art, e.g., a source which effectively radiates ultraviolet light such as a carbon arc lamp, mercury vapor arc lamp, super high-voltage mercury lamp, high-voltage mercury lamp or xenon lamp. Alternatively, it may be a source which effectively radiates visible light such as a photographic flood lamp or sun lamp.

After exposure, parts other than the exposed part are removed using an alkaline aqueous solution by a method known in the art, e.g., spraying, oscillating immersion, brushing or scrubbing so as to form a resist pattern. After forming the resist pattern, post-curing may be further performed by exposure at 1-5 J/cm² or heating to 100-200° C. for 30 minutes-12 hours.

The alkaline aqueous solution is preferably a 0.1-5 wt % dilute sodium carbonate solution, 0.1-5 wt % dilute potassium carbonate solution, 0.1-5 wt % dilute sodium hydroxide solution, or 0.1-5 wt % dilute sodium tetraborate solution. The pH of the alkaline aqueous solution used for developing is preferably within the range of 9-11, and the temperature is adjusted to suit the developing properties of the photosensitive resin composition layer. The alkaline aqueous solution may further contain a surfactant, an anti-foaming agent or a small amount of an organic solvent to promote developing.

By the aforesaid method, a resist pattern can be formed on the photosensitive resin composition layer laminated on the conductor layer wherein a circuit pattern is formed. When actual components are connected, the photosensitive resin composition layer wherein the resist pattern was formed functions as a solder resist to prevent adhesion of solder to unnecessary parts on the conductive layer.

Since this solder resist uses the photosensitive resin composition of the invention, a high resolution resist pattern can be formed, and since this solder resist has excellent adhesion to the conductive layer, there is very little peeling away from the conductor layer. In addition, PCT characteristics, electrical corrosion resistance, heat resistance and thermal impact resistance are excellent.

(Printed Circuit Board)

FIG. 2 shows a schematic cross-sectional view of one embodiment of the printed circuit board of the invention. This printed circuit board 11 comprises an insulating substrate 12, a conductive layer 14 having a circuit pattern formed on the insulating substrate, and a resist layer 16 formed on the insulating substrate 12 so as to cover the conductive layer 14. The resist layer 16 is formed from the cured photosensitive resin layer composition of the invention, and the resist layer 16 has an opening 18 so that at least part of the conductive layer 4 is exposed.

Since the printed circuit board 11 has the opening 18, in a CSP or BGA, actual components, not shown, can be connected to the conductive circuit 14 by solder or the like, i.e., surface mounting is possible. The resist layer 16 has the role of a solder resist to prevent solder from adhering to unnecessary parts of the conductive layer 14 when soldering is performed to make connections. Also, after components have been connected, it also functions as a permanent mask to protect the conductive layer 14.

The printed circuit board 11 may for example be manufactured as follows. First, the pattern of the conductive layer 14 is formed on the insulating substrate 12 by a method known in the art, e.g., by etching a metal foil-covered laminated plate (e.g., copper-covered laminated plate). Next, the photosensitive resin composition layer of the photosensitive resin composition of the invention is laminated on the insulating substrate 12 wherein the conductor layer 14 is formed so as to cover the conductive layer 14. Curing is then performed by irradiating the laminated photosensitive resin composition layer with the activation light via a mask having a predetermined pattern, and the resist layer 16 having the opening 18 is formed by removing the unexposed parts (e.g., by alkali developing). If the photosensitive resin composition contains a volatile component such as a solvent, the resist layer 16 becomes the cured product of the photosensitive resin layer composition after most of this volatile component has been removed.

The lamination of the photosensitive resin layer composition on the insulating substrate 12, irradiation with the activation light and removal of unexposed parts are performed by identical methods to those used in the aforesaid resist pattern-forming method.

The resist layer 16 in the printed circuit board 11 is the cured product of the photosensitive resin composition of the invention, and since it has excellent adhesion to the conductive layer 14, there is little peeling away from the conductive layer 14, and PCT characteristics, electrical corrosion resistance, heat resistance and thermal impact resistance are excellent.

### EXAMPLES

The present invention will now be described in further detail referring to specific examples, but it should be understood that the invention is not to be construed as being limited in any way thereby.

### Synthesis Example 1

### Synthesis of Component A

400 wt parts of YDPF-1000 (Toto Kasei) which is Component A1, 72 wt parts of acrylic acid which is Component A2, 0.5 wt parts of methyl hydroquinone and 120 wt parts of carbitol acetate were placed in a reaction vessel, and reacted together while dissolving the mixture by heating to 90° C. with stirring. Next, the obtained solution was cooled to 60° C., 2 wt parts of triphenylphosphine was added, the mixture heated to 100° C., and the reaction carried out until the acid value of the solution became 1 mgKOH/g or less. To the solution after the reaction, 100 wt parts of tetrahydrophthalic anhydride as Component A4 and 85 wt parts of carbitol acetate were added, the mixture heated to 80° C., reacted for approximately 6 hours and cooled to obtain a solution of Component A having a solids concentration of 75 wt %.

### Synthesis Example 2

### Synthesis of Non-elastomer-Like Polymer of Polymerizable Compound having Carbon-Carbon Double Bond

Methacrylic acid, methyl methacrylate, butyl methacrylate and 2-ethylhexyl acrylate as the polymerizable compound having a carbon-carbon double bond (weight ratio: methacrylic acid/methyl methacrylate/butyl methacrylate/2-ethylhexyl acrylate=25/50/5/20), were copolymerized in a methyl cellosolve/toluene solvent (mixed solvent having a weight ratio of 6/4) to obtain a methyl cellosolve/toluene solution containing 40 wt % of a copolymer (hereafter, this copolymer will be referred to as “Component E”) having a weight average molecular weight of 80,000.

### Comparative Synthesis Example 1

382 wt parts of cresol Novolak epoxy resin (ESCN-195, Sumitomo Chemicals), 90 wt parts of acrylic acid, 0.5 wt parts of methyl hydroquinone and 120 wt parts of carbitol acetate were placed in a reaction vessel, and reacted together while dissolving the mixture by heating to 90° C. with stirring. Next, the obtained solution was cooled to 60° C., 2 wt parts of triphenylphosphine was added, the mixture heated to 100° C., and the reaction carried out until the acid value of the solution became 1 mgKOH/g or less. To the solution after the reaction, 100 wt parts of tetrahydrophthalic anhydride and 85 wt parts of carbitol acetate were added, the mixture heated to 80° C., reacted for approximately 6 hours and cooled to obtain a solution having a solids concentration of 75 wt %.

### Examples 1-10 and Comparative Examples 1-2

Using the solutions obtained in Synthesis Example 1, Synthesis Example 2 and Comparative. Synthesis Example 1, Composition a and Composition b of Examples 1-10 and Comparative Examples 1-2 were respectively blended in accordance with the proportions indicated in table 1 and 2, and kneaded in a 3 roll mill. Next, 70 wt parts of Composition a and 30 wt parts of Composition b were blended together to obtain the photosensitive resin compositions of Examples 1-10 and Comparative Examples 1-2.

TABLE 1

| Component | | | Example 1 | Example 2 | Example 3 | Example 4 | Example 5 |
|---|---|---|---|---|---|---|---|
| Composition a: | Component A | Solution of | 86 | 80 | 80 | 80 | 75 |
| | | Synthesis Example 1 | | | | | |
| | | Solution of | — | — | — | — | — |
| | | Comparative | | | | | |
| | | Synthesis Example 1 | | | | | |
| | Component C | Irgacure 907*¹ | 7 | 7 | 7 | 7 | 7 |
| | | Kayacure DETX-S*² | 2 | 2 | 2 | 2 | 2 |
| | Elastomer | XER-91*³ | — | 6 | — | — | 3 |
| | Phenoxy | YP-50*⁴ | — | — | 6 | — | 3 |
| | resin | | | | | | |
| | Block | BL-3257*⁵ | — | — | — | 6 | 5 |
| | isocyanate | | | | | | |
| | Epoxy resin | C11Z-A*⁶ | 2 | 2 | 2 | 2 | 2 |
| | curing agent | | | | | | |
| | Component E | Solution of | — | — | — | — | — |
| | | Synthesis Example 2 | | | | | |
| | Other | Phthalocyanine | 1 | 1 | 1 | 1 | 1 |
| | components | green | | | | | |
| | | γ-glycidoxypropyl | 1 | 1 | 1 | 1 | 1 |
| | | triethoxysilane | | | | | |
| | | Barium sulfate | 10 | 10 | 10 | 10 | 10 |
| | | Silica | 20 | 20 | 20 | 20 | 20 |
| | | Talc | 5 | 5 | 5 | 5 | 5 |
| Composition b | Component B | Kayarad DPHA*⁷ | 10 | 10 | 10 | 10 | 10 |
| | Component D | ESLV-120TE*⁸ | 15 | 15 | 15 | 15 | 15 |
| | | Carbitol acetate | 15 | 15 | 15 | 15 | 15 |
| | Other | Silica | 20 | 20 | 20 | 20 | 20 |
| | components | Barium sulfate | 30 | 30 | 30 | 30 | 30 |

TABLE 2

| | Component | | Ex. 6 | Ex. 7 | Ex. 8 | Ex. 9 | Ex. 10 | Comp. Ex.. 1 | Comp. Ex.. 2 |
|---|---|---|---|---|---|---|---|---|---|
| Composition | Component A | Solution of Synthesis | 76 | 70 | 80 | 80 | 75 | — | — |
| a | | Example 1 | | | | | | | |
| | | Solution of | — | — | — | — | — | 86 | 80 |
| | | Comparative | | | | | | | |
| | | Synthesis Example 1 | | | | | | | |
| | Component C | Irgacure 907*¹ | 7 | 7 | 7 | 7 | 7 | 7 | 7 |
| | | Kayacure DETX-S*² | 2 | 2 | 2 | 2 | 2 | 2 | 2 |
| | Elastomer | XER-91*³ | — | 6 | — | — | 3 | — | 6 |
| | Phenoxy resin | YP-50*⁴ | — | — | 6 | — | 3 | — | — |
| | Block | BL-3257*⁵ | — | — | — | 6 | 5 | — | — |
| | isocyanate | | | | | | | | |
| | Epoxy resin | C11Z-A*⁶ | 2 | 2 | 2 | 2 | 2 | 2 | 2 |
| | curing agent | | | | | | | | |
| | Component E | Solution of Synthesis | 10 | 10 | 10 | 10 | 10 | — | — |
| | | Example 2 | | | | | | | |
| | Other | Phthalocyanine green | 1 | 1 | 1 | 1 | 1 | 1 | 1 |
| | components | γ-glycidoxypropyl | 1 | 1 | 1 | 1 | 1 | 1 | 1 |
| | | triethoxysilane | | | | | | | |
| | | Barium sulfate | 10 | 10 | 10 | 10 | 10 | 10 | 10 |
| | | Silica | 20 | 20 | 20 | 20 | 20 | 20 | 20 |
| | | Talc | 5 | 5 | 5 | 5 | 5 | 5 | 5 |
| Composition | Component B | Kayarad DPHA*⁷ | 10 | 10 | 10 | 10 | 10 | 10 | 10 |
| b | Component | ESLV-120TE*⁸ | 15 | 15 | 15 | 15 | 15 | 15 | 15 |
| | D | | | | | | | | |
| | Other | Carbitol acetate | 15 | 15 | 15 | 15 | 15 | 15 | 15 |
| | components | Silica | 20 | 20 | 20 | 20 | 20 | 20 | 20 |
| | | Barium sulfate | 30 | 30 | 30 | 30 | 30 | 30 | 30 |

The figures for the components in the tables represent wt parts. Also, *1-*8 signify the following compounds:
1:2-methyl-1-[4-(methylthio)phenyl]-2-morpholinopropane-1-one (Ciba-Geigy)
2: 2,4-diethylthioxanthone (Nippon Kayaku)
3: Biterminal carboxy-modified butadiene-acrylonitrile copolymer (Nippon Synthetic Rubber)
4: Phenoxy resin (Toto Kasei)
5: Block isocyanate (Sumitomo Bayer)
6: 2,4-diamino-6-[2′-undecylimidazole-(1′)]-ethyl-S-triazine (Shikoku Kasei)
7: Dipentaerythritol hexacrylate (Nippon Kayaku)
8: 1,3,5-triglycidyl isocyanurate (Shinnitetsu Chemicals)

The photosensitive resin compositions obtained in Examples 1-10 and Comparative Examples 1-2 were coated on a copper-coated laminated plate to a post-drying thickness of approximately 30 μm by the screen printing method using a 120 mesh Tetrone screen, and dried at 80° C. for 30 minutes in a hot air recirculation drier to obtain a copper-coated laminated plate with resin having a substrate, copper foil layer and photosensitive resin composition layer in this order.

Using this copper-coated laminated plate with resin, developing properties, adhesion properties, solder heat-resistance, electrical corrosion resistance, thermal impact resistance and PCT resistance were evaluated by the following methods. Table 3 and 4 summarize the obtained results.

(Developing Properties)

21 step tablet (Stauffer) were stuck onto the photosensitive resin composition layer on the copper-coated laminated plate with resin obtained above, exposed at an integrated exposure amount of 500 mJ/cm² using an ultraviolet light exposure device, and spray-developed 60 seconds with a 1% sodium carbonate aqueous solution. The presence or absence of developing residues was examined by visual observation of the copper-coated laminated plate with resin after developing, and evaluated according to the following criteria:
A: No developing residues
B: Developing residues

In the following evaluation, tests were performed using a test plate having a resist pattern according to the following method.

A negative mask having a predetermined pattern was stuck to a photosensitive resin composition layer on a copper-coated laminated plate with resin, and exposed to 500 mJ/cm² by an ultraviolet light exposure device. Next, spray-developing was performed at a pressure of 1.8 kgf/cm² for 60 seconds using a 1% sodium carbonate aqueous solution to eliminate unexposed parts, and heating was performed at 150° C. for 1 hour to obtain a test plate.

(Adhesion Properties)

A peeling test was performed according to a method based on JIS K5400 using the obtained test plate. Specifically, 100×1 mm grids were prepared on the photosensitive resin composition layer of the test plate, and a cellophane tape stuck to the grids was then peeled off. The peeling state of the grids after peeling the tape off was examined, and adhesion properties were evaluated according to the following criteria:
A: 90/100 or more grids showed no peeling.
B: 50/100 to less than 90/100 grids showed no peeling.
C: Less than 50/100 grids showed no peeling.

(Solder Heat Resistance)

A water-soluble flux was coated on the. photosensitive resin composition layer of the obtained test plate, and immersed in a solder bath at 260° C. for 10 seconds. After repeating this 6 times, the appearance of the coating film was examined, and the solder heat resistance was evaluated according to the following criteria:
A: Peeling or blistering of coating film did not occur, and intrusion of solder did not occur.
B: Peeling of blistering of coating film occurred, or intrusion of solder occurred.

(Electrical Corrosion Resistance)

The obtained test plate was left at 85° C., 85%RH and 100V for 1000 hours. The insulation resistance value of the photosensitive resin composition layer was measured, and the electrical corrosion resistance was evaluated according to the following criteria:
A: Insulation resistance value was 10¹⁰ Ω or more,
B: Insulation resistance value was 10⁸ Ω to less than 10¹⁰ Ω.
C: Insulation resistance value was less than 10⁸ Ω.

(Thermal Impact Resistance)

The obtained test plate was left at −55° C. for 30 minutes, and then at 125° C. for 30 minutes. Taking this as one cycle, 500 cycles were performed, the test plate was examined visually and by a microscope, and thermal impact resistance was evaluated according to the following criteria:
A: No cracks.
B: Cracks.

(PCT Resistance)

The obtained test plate was left at 121° C. under 2 atmospheres for a predetermined time (PCT treatment), and the coating film was visually examined. An identical peeling test to that in the adhesion test was performed using the test plate after PCT treatment. The coating film appearance and adhesive properties after PCT treatment were evaluated according to the following criteria for coating film appearance, and according to identical criteria to those used in the adhesion test for adhesive properties.
A: No blistering or white blistering of coating film.

B: blistering or white blistering occurred in coating film.

TABLE 3

| Item | | | Example 1 | Example 2 | Example 3 | Example 4 | Example 5 |
|---|---|---|---|---|---|---|---|
| Developing properties | | | A | A | A | A | A |
| Adhesion properties | | | A | A | A | A | A |
| Solder heat resistance | | | A | A | A | A | A |
| Electrical corrosion resistance | | | A | A | A | A | A |
| Thermal impact resistance | | | A | A | A | A | A |
| PCT | After | Coating | A | A | A | A | A |
| resistance | 96 | film | | | | | |
| | hours | appearance | | | | | |
| | | Adhesion | A | A | A | A | A |
| | | properties | | | | | |
| | After | Coating | A | A | A | A | A |
| | 168 | film | | | | | |
| | hours | appearance | | | | | |
| | | Adhesion | A | A | A | A | A |
| | | properties | | | | | |

TABLE 4

| Item | | | Ex. 6 | Ex. 7 | Ex. 8 | Ex. 9 | Ex. 10 | Comp. Ex. 1 | Comp. Ex. 2 |
|---|---|---|---|---|---|---|---|---|---|
| Developing properties | | | A | A | A | A | A | A | A |
| Adhesion properties | | | A | A | A | A | A | A | A |
| Solder heat resistance | | | A | A | A | A | A | A | A |
| Electrical corrosion resistance | | | A | A | A | A | A | B | A |
| Thermal impact resistance | | | B | B | B | B | A | C | C |
| PCT | After | Coating film | A | A | A | A | A | B | B |
| resistance | 96 | appearance | | | | | | blistering | blistering |
| | hours | Adhesion | A | A | A | A | A | B | B |
| | | properties | | | | | | | |
| | After | Coating film | B | A | A | A | A | B | B |
| | 168 | appearance | White | | | | | White | White |
| | | | blistering | | | | | blistering | glistering |
| | hours | Adhesion | B | A | A | A | A | B | B |
| | | properties | | | | | | | |

### INDUSTRIAL APPLICABILITY

According to the present invention, a high resolution resist pattern can be formed, and when this pattern is used as the solder resist of a printed circuit board, adhesion to a conductive layer is excellent. Hence, a photosensitive resin composition can be provided which can form a solder resist having excellent PCT resistance, electrical corrosion resistance, heat resistance and thermal impact resistance.

The invention further provides a resist pattern-forming method which permits high resolution to be obtained using the photosensitive resin composition of the invention, and a printed circuit board having an insulating layer formed by this resist pattern pattern-forming method.

1. A photosensitive resin composition, comprising:
(A) a polymer having a carbon-carbon double bond and carboxyl group, formed by the reaction of an acid anhydride with the reaction product of an epoxy compound having a repeating unit expressed by the following general formula
(1a) and a repeating unit expressed by the following general formula (1b) with an unsaturated carboxyl compound having a carbon-carbon double bond and a carboxyl group,
(B) a photopolymerizable monomer,
(C) a radical photopolymerization initiator, and
(D) a curing agent having reactivity with a functional group of said polymer and/or said photopolymerizable monomer: 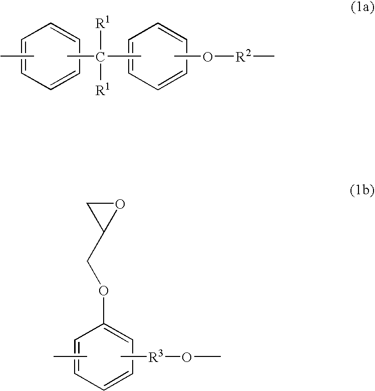
[in the formula, R¹ is a hydrogen atom or methyl group, R², R³ are alkylene groups].

2. The photosensitive resin composition according to claim 1, wherein said epoxy compound is an epoxy compound expressed by the following general formula (2): 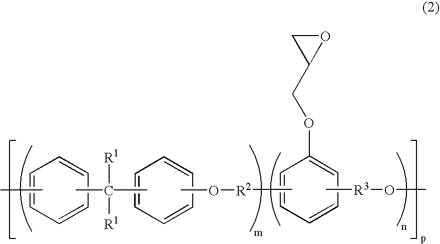
[in the formula, R¹ is a hydrogen atom or methyl group, R², R³ are alkylene groups, m, n are positive integers such that m+n=2-50, and p is a positive integer].

3. The photosensitive resin composition according to claim 1, wherein said unsaturated carboxyl compound is a compound expressed by the following general formula (3): 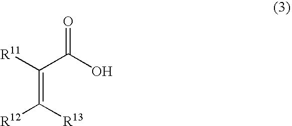
[in the formula, R¹¹ is a hydrogen atom or alkyl group, and R¹², R¹³ are independently a hydrogen atom, alkyl group, aryl group, styryl group, furfuryl group or cyano group].

4. The photosensitive resin composition according to claim 1, wherein said unsaturated carboxyl compound is (meth)acrylic acid.

5. The photosensitive resin composition according to claim 1, wherein said unsaturated carboxyl compound is a monoester of a dibasic acid having a carbon-carbon double bond.

6. The photosensitive resin composition according to claim 5, wherein said monoester is a monoester obtained by reacting an acid anhydride with a (meth)acrylate compound having a hydroxyl group.

7. The photosensitive resin composition according to claim 1, further containing an elastomer.

8. The photosensitive resin composition according to claim 1, further containing a phenoxy resin.

9. The photosensitive resin composition according to claim 1, further containing a block isocyanate.

10. The photosensitive resin composition according to claim 1, further containing a non-elastomer-like polymer of a polymerizable compound having a carbon-carbon double bond.

11. A photosensitive element comprising a support, and a photosensitive resin composition layer composed of the photosensitive resin composition according to claim 1 formed on said support.

12. A method of forming a resist pattern, comprising the steps of:
laminating a photosensitive resin composition layer of the photosensitive resin composition according to claim 1 so as to cover a conductive layer, on an insulating substrate of a laminated substrate comprising said insulating substrate and said conductive layer having a circuit pattern formed on said insulating substrate,
forming an exposed part by irradiating a predetermined part of said photosensitive resin composition layer with an activation light, and
removing parts except said exposed part in said photosensitive resin composition layer.

13. A printed circuit board, comprising an insulating substrate, a conductive layer having a circuit pattern formed on said insulating substrate and a resist layer formed on said insulating substrate so as to cover said conductive layer, wherein:
said resist layer is the cured product of the photosensitive resin composition according to claim 1, and said resist layer has an opening so that at least part of said conductive layer is exposed.

14. The photosensitive resin composition according to claim 2, wherein said unsaturated carboxyl compound is a compound expressed by the following general formula (3): 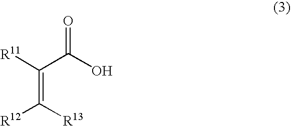
[in the formula, R“is a hydrogen atom or alkyl group, and R¹², R¹³ are independently a hydrogen atom, alkyl group, aryl group, styryl group, furfuryl group or cyano group].

15. The photosensitive resin composition according to claim 2, wherein said unsaturated carboxyl compound is (meth)acrylic acid.

16. The photosensitive resin composition according to claim 3, wherein said unsaturated carboxyl compound is (meth)acrylic acid.

17. The photosensitive resin composition according to claim 2, wherein said unsaturated carboxyl compound is a monoester of a dibasic acid having a carbon-carbon double bond.
